(19) United States
(12) Patent Application Publication
(10) Pub. No.: US 2014/0078771 A1
(43) Pub. Date: Mar. 20, 2014

(54) LIGHT DEVICE

(71) Applicant: LEXTAR ELECTRONICS CORPORATION, Hsinchu (TW)

(72) Inventors: Chun-Kuang Chen, Taipei City (TW); Chia-Lun Tsai, Dacheng Township (TW); Fu-Tse Tang, New Taipei City (TW)

(73) Assignee: LEXTAR ELECTRONICS CORPORATION, Hsinchu (TW)

(21) Appl. No.: 13/845,457

(22) Filed: Mar. 18, 2013

(30) Foreign Application Priority Data
Sep. 20, 2012 (TW) 101134507

(51) Int. Cl. F21V 29/00; F21V 8/00

(52) U.S. Cl. CPC F21V 29/22; G02B 6/0001
USPC 362/555; 362/580

(57) ABSTRACT

A light device includes a light transmission tube, a heat sink, a light bar, and two end caps. The light transmission tube has two securing parts. Each of the securing parts includes a first rib and a second rib, and a guide-track groove is formed between the first and second ribs. The heat sink includes a first plate body and a second plate body. The first plate body is curved and abutted on an inner wall of the light transmission tube, and the second plate body is curved toward the first plate body. Two terminals of the first plate body are connected to two terminals of the second plate body to form two connecting parts for coupling with the guide-track grooves. The light bar is disposed on the second plate body. The end caps are respectively connected to two terminals of the light transmission tube.

### RELATED APPLICATIONS

This application claims priority to Taiwan Application Serial Number 101134507, filed Sep. 20, 2012, which is herein incorporated by reference.

### BACKGROUND

1. Field of Invention

The present invention relates to a light device. More particularly, the present invention relates to a light-emitting diode (LED) light tube.

2. Description of Related Art

The light-emitting diode (LED) has many advantages like smaller size, electricity saving, fast responding time, and various colors. Therefore, the LED has been widely used in a lighting tube or bulb in a lamp.

The LED is a type of semiconductor light emitting device which produces heat and high temperature in the conversion of electricity into light. When the temperature raises 1° C., the lighting efficiency of the light-emitting diode decreases 0.9%. Thus, how to efficiently dissipate heat is always an important issue in the art.

To solve the problems resulted from the raise of temperature in use of the LED, a heat sink is usually disposed on the light-emitting diode. The heat sink is a strip structure of a heat-conductive metal like aluminum formed by extrusion processing. However, the heat sink is not isolated disposed in the light transmission tube such that the user may get an electric shock in replacing the tube in the lamp.

FIG. 1 shows a cross-section view of a conventional light device 10. A heat sink 11 made by the aluminum extrusion process is guided into a transparent tube 12 from both lateral sides of the transparent tube 12 and a light bar 13 is disposed on the heat sink 11 for illumination. When the transparent tube 12 is becoming longer, the transparent tube 12 is easily subject to a bent deformation in length due to self-weight. Furthermore, after the transparent tube 12 used for a long time, the heat sink 11 may also be thermally deformed by the excessive heat absorbed in the heat sink 11 from the light bar 13.

Therefore, there is a need to develop a light device that is capable of avoiding the foregoing disadvantages.

### SUMMARY

In accordance with the present invention, a light device includes a light transmission tube, a heat sink, a light bar, and two end caps. The light transmission tube has two securing parts, in which each of the securing parts includes a first rib and a second rib and forms a guide-track groove between the first rib and the second rib. The heat sink includes a first plate body and a second plate body, in which the first plate body is curved and is abutted on an inner wall of the light transmission tube and the second plate body is curved in a direction of the first plate body. Two terminals of the first plate body are connected to two terminals of the second plate body to form two connecting parts for respectively coupling with the guide-track grooves and a cavity is formed between the first plate body and the second plate body. The light bar is disposed on the second plate body. The end caps are correspondingly connected to two terminals of the light transmission tube.

According to another embodiment disclosed herein, each of the first ribs has an L-shaped section.

According to another embodiment disclosed herein, each of the first ribs extends from an inner wall of the light transmission tube in a vertical direction and a terminal of each of the first ribs is curved to the second plate body to form the L-shaped section.

According to another embodiment disclosed herein, each of the connecting parts has a locking hole.

According to another embodiment disclosed herein, each of the locking holes is a C-shaped locking hole.

According to another embodiment disclosed herein, each of the end caps includes an arc rib and the arc ribs are insert into the cavity and contact with the first plate body.

According to another embodiment disclosed herein, the heat sink is an aluminous heat sink.

According to another embodiment disclosed herein, the light transmission tube is a plastic light transmission tube.

According to another embodiment disclosed herein, a central of the second plate body has a plane and the light bar is disposed on the plane.

According to another embodiment disclosed herein, the light bar is a light-emitting diode (LED) light bar.

Thus, the light transmission tube becomes stronger to prevent the overloading deformation of the light transmission tube because the first plate body is tightly abutted on the inner wall of the light transmission tube and the arc ribs are inserted into the cavity and contact with the first plate body. In addition, the light bar lights uniformly because the light bar disposed on the second plate body of the heat sink is far from the wall of the light transmission tube. Furthermore, the heat sink is hermetically disposed in the light transmission tube such that the user cannot get an electric shock when the user changes the light transmission tube.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a cross-section view of a conventional light device;

FIG. 2 illustrates a perspective view of a light device according to an embodiment of the present invention is applied;

FIG. 3 illustrates an exploded view of the light device of FIG. 2;

FIG. 4 illustrates a cross-section view of the light device cross the cross-section line 3-3′ of FIG. 2; and

FIG. 5 illustrates a cross-section view of the light device cross the cross-section line 4-4′ of FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

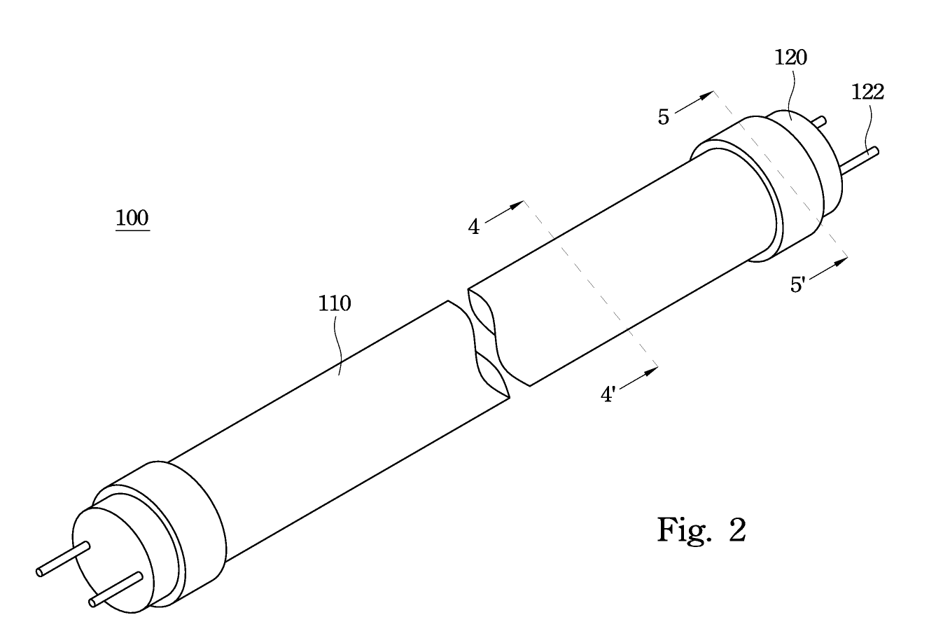

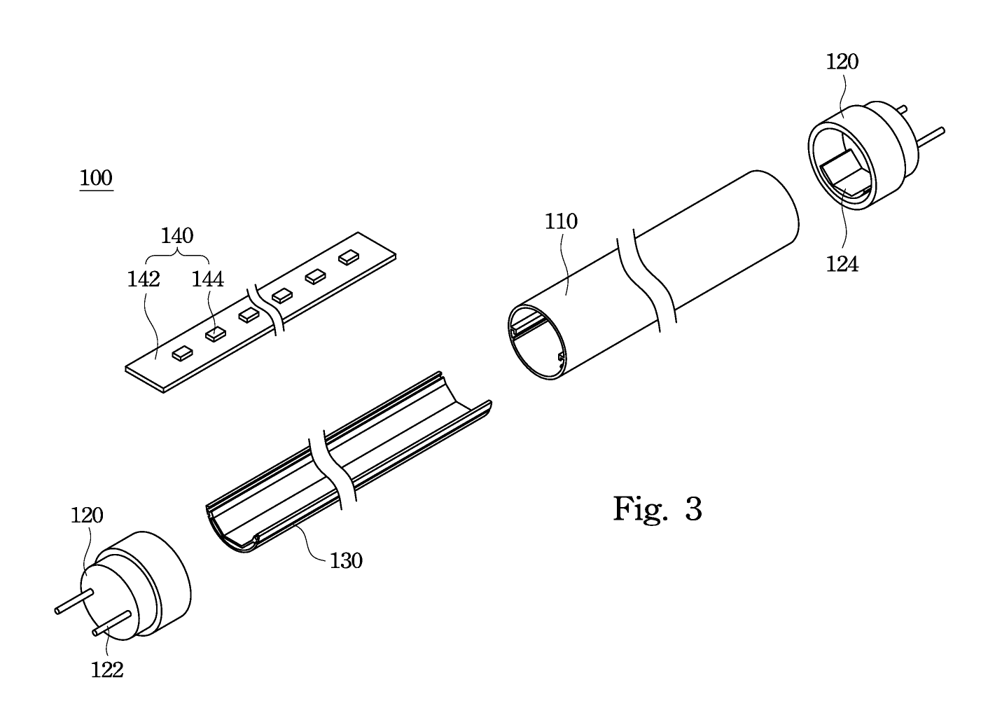

FIG. 2 shows a perspective view of a light device 100 according to an embodiment of the present invention is applied, and FIG. 3 illustrates an exploded view of the light device 100 of FIG. 2. The light device 100 includes a light transmission tube 110 and two end caps 120, in which two laterals of the light transmission tube 110 are respectively coupled with the end caps 120. A heat sink 130 is disposed in an inner of the light transmission tube 110 and a light bar is disposed on the heat sink 130. When the light bar 140 produces heat in use, the heat sink 130 absorbs the heat generated by the light bar 140 and dissipates the heat. In addition, the light bar 140 includes a substrate 142 and several light elements 144, in which the light elements 144 are disposed on the substrate 142. When the substrate 142 receives electrical power, the light elements 144 can emit light because the light elements 144 are electrically connected to the substrate 142. In this embodiment, the substrate 142 may be a printed circuit board. However, after terminals 122 of the end caps 120 are electrically coupled with a socket, the electrical power is received by the substrate 142 and is transported to the light elements 144 such that the light elements 144 emit light. In this embodiment, the light bar 140 is a light-emitted diode (LED) light bar. Thus, the light elements 144 are LED elements. In this embodiment, the light elements 144 are in 3014, 5630 of specifications of surface mounted device (SMD) or other LED specifications. The light transmission tube 110 is made by a cannular structure that consists of a light transmission elastic material (ex: a plastic material). The light transmission tube 110 is an insulator such that the light transmission tube 110 can protect a user from getting an electric shock when the user touches the light transmission tube 110. Thus, the light transmission tube 110 may be a plastic tube. In addition, the heat sink 130 is a strip structure made by an aluminum extrusion processing. In other words, the heat sink 130 is an aluminum heat sink.

The heat sink 130 is made by aluminum material because the aluminum material has a good heat conducting effect such that the heat sink 130 can dissipate heat produced by the light bar 140 to prevent that light efficiency of the light bar 140 lower because the light bar 140 produces a temperature raising effect. In addition, the heat sink 130 is hermetically disposed in the light transmission tube 110 so as to eliminate the potential danger caused from the replacement of the light transmission tube 110.

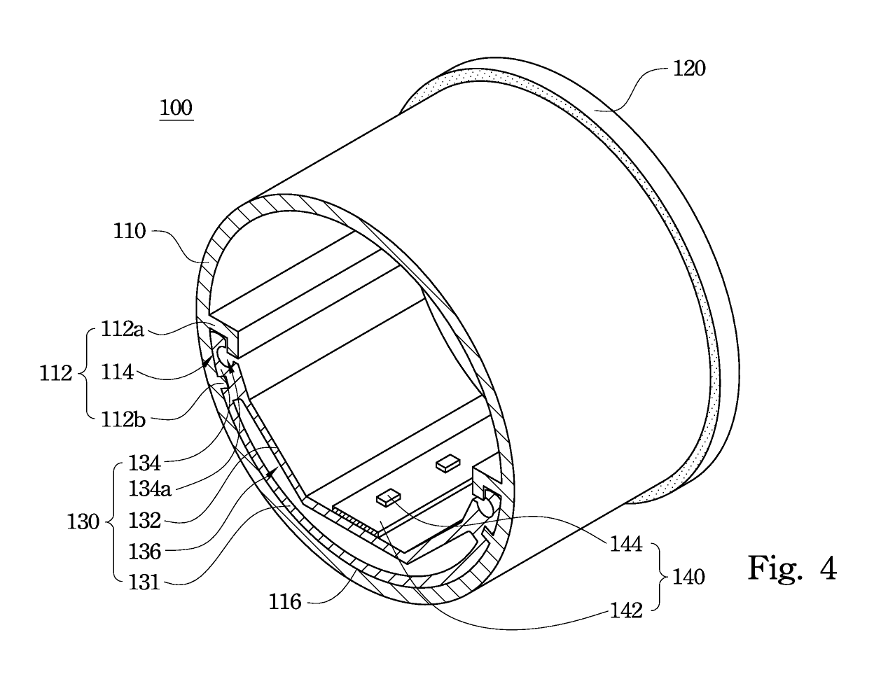

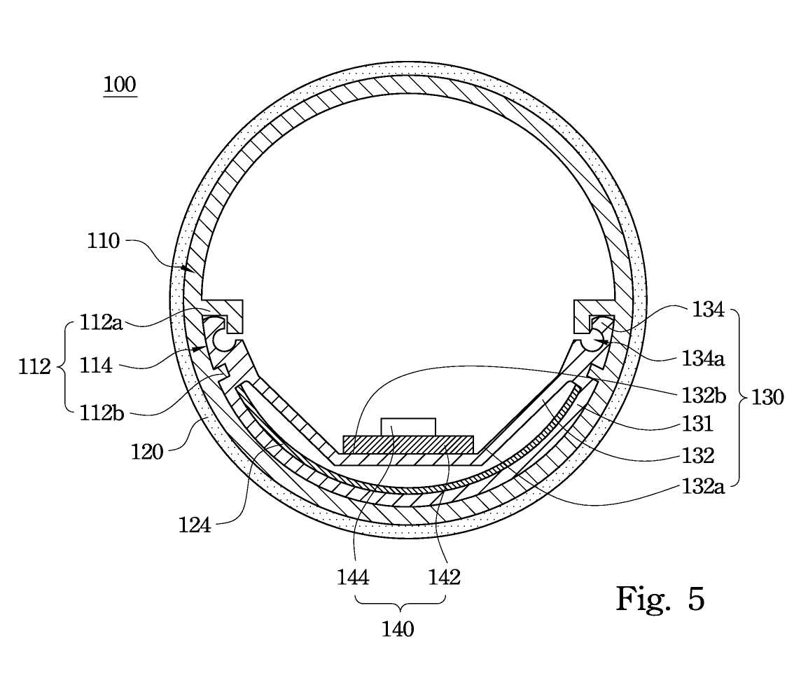

FIG. 4 shows a cross-section view of the light device cross the cross-section line 3-3′ of FIG. 2, and FIG. 5 illustrates a cross-section view of the light device cross the cross-section line 4-4′ of FIG. 2. An inner wall 116 of the light transmission tube 110 has two securing parts 112. In this embodiment, the two securing parts 112 are opposite to each other. In which, each of the securing parts 112 includes a first rib 112a and a second rib 112b. The first rib 112a, the second rib 112b and the inner wall 116 form a guide-track groove 114. In the other words, the guide-track groove 116 is formed between the first rib 112a and the second rib 112b. In this embodiment, each of the first ribs 112a has a L-shaped section and each of the first ribs 112a extends from an inner wall 116 of the light transmission tube 110 in a vertical direction and a terminal of each of the first ribs 112a is curved to the second plate body 132 of the heat sink 130 to form the L-shaped section.

However, the heat sink 130 includes a first plate body 131 and the second plate body 132. The first plate body 131 is curved and is abutted on the inner wall 116 of the light transmission tube 110. The light transmission tube 110 is stronger to prevent the overloading deformation of the light transmission tube 110 because the first plate body 131 is tightly abutted on the inner wall 116 of the light transmission tube 110. Furthermore, the second plate body 132 is curved in a direction of the first plate body 131. For example, the second plate body 132 has two curved parts 132a. An included angle of each of the two curved parts 132a is more than 90°. In addition, a plane 132b is formed between the two curved parts 132a. In other words, a central of the second plate body 132 has the plane 132b and the light bar 140 is disposed on the plane 132b. In this embodiment, the substrate 142 of the light bar 140 is adhered on the plane 132b of the second plate body 132 with a viscose for adhering the light bar 140 on the second plate body 132. The viscose coated on the substrate 142 may transmit heat produced by the light bar 140 lighting to the heat sink 130 and prevent the light bar 140 against over heat to affect the luminance of the light bar 140.

After two terminals of the first plate body 131 are connected to two terminals of the second plate body 132, the terminals of the first plate body 131 and the terminals of the second plate body 132 form two connecting parts 134 for being respectively engaged with the guide-track grooves 114. In addition, each of the connecting parts 134 has a locking hole 134a for an insulating screw. When the insulating screw is coupled with the locking hole 134a, the guide-track grooves 114 may be steadily secured with the connecting parts 134. In this embodiment, each of the locking holes 134a is a C-shaped locking hole. Therefore, terminals of the connecting parts 134 are respectively engaged with the L-shaped section of the first ribs 112a such that the connecting parts 134 are much tightly engaged with the guide-track grooves 114. In others embodiment, each of the locking holes 134a may be an others-shaped locking hole. For example, each of the locking holes 134a may be a circular-shaped locking hole. Furthermore, a cavity 136 is formed between the first plate body 131 and the second plate body 132. The cavity 136 increases room for the heat sink 130 dissipating heat to improve the heat dissipation ability of the heat sink 130.

In addition, each of the end caps 120 includes an arc rib 124. When the light transmission tube 110 is coupled with the end caps 120, the arc ribs 124 are inserted into the cavity 136 and contact with the first plate body 131 such that the first plate body 131 is engaged between the arc ribs 124 and the inner wall 116 of the light transmission tube 110. The light transmission tube 110 is enough stronger to prevent the overloading deformation of the light transmission tube 110 because the first plate body 131 is engaged between the arc ribs 124 and the inner wall 116 of the light transmission tube 110.

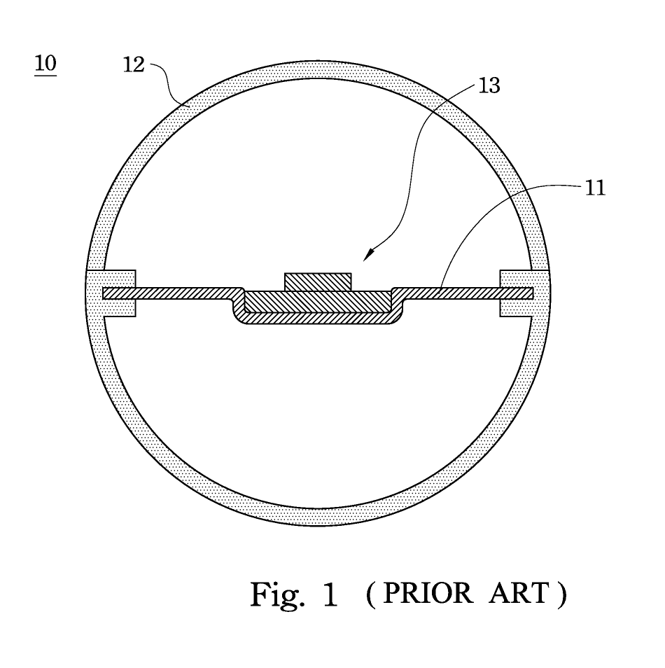

Therefore, comparing with the conventional light device 10 of FIG. 1 and the light device 100 according to this embodiment, the conventional light device 10 and the light device 100 are respectively added objects on central of their terminals. In which, each of the objects is located on one of the central of their terminals. The weight of each of the objects is 0.5 kg, 1.0 kg, and 1.5 kg. And then, recording the deformation of the conventional light device 10 and the light device 100 added the objects having different weight and getting a table. 1:

TABLE 1

| | | deformation amount (mm) | | |
|---|---|---|---|---|
| | | Add a object | Add a object | Add a object |
| | weight (g) | (having 0.5 Kg) | (having 1.0 Kg) | (having 1.5 Kg) |
| The light device | 149 | 2.2 | 4.7 | 7.2 |
| 100 of this | | | | |
| embodiment | | | | |
| The conventional | 70 | 5.3 | 10.2 | 18.5 |
| light device 10 of | | | | |
| FIG. 1 | | | | |

As shown in table.1, the light device 100 has less deformation than the conventional light device 10, when the objects loaded by them have the same weight. Thus, the light device 100 has more steady structure than the conventional light device 10.

According to above-described embodiments, the light transmission tube becomes stronger to prevent the overloading deformation of the light transmission tube because the first plate body is tightly abutted on the inner wall of the light transmission tube and the arc ribs are insert into the cavity and contact with the first plate body. In addition, the light bar lights uniformly because the light bar disposed on the second plate body of the heat sink is far from the wall of the light transmission tube. Furthermore, the heat sink is hermetically disposed in the light transmission tube such that the user cannot get an electric shock when the user changes the light transmission tube.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light device comprising:
a light transmission tube having two securing parts, each of the securing parts comprising a first rib and a second rib and a guide-track groove between the first rib and the second rib;
a heat sink comprising a first plate body and a second plate body, wherein the first plate body is curved and abutted on an inner wall of the light transmission tube and the second plate body is curved in a direction of the first plate body, two terminals of the first plate body connected to two terminals of the second plate body to form two connecting parts for respectively coupling with the guide-track grooves and a cavity formed between the first plate body and the second plate body;
a light bar disposed on the second plate body; and
two end caps correspondingly connected to two terminals of the light transmission tube.

2. The light device of claim 1, wherein each of the first ribs has an L-shaped cross section.

3. The light device of claim 2, wherein each of the first ribs extends from an inner wall of the light transmission tube in a vertical direction and a terminal of each of the first ribs is curved to the second plate body to form the L-shaped cross section.

4. The light device of claim 1, wherein each of the connecting parts has a locking hole.

5. The light device of claim 4, wherein each of the locking holes is a C-shaped locking hole.

6. The light device of claim 1, wherein each of the end caps comprises an arc rib and the arc ribs are insert into the cavity and contact with the first plate body.

7. The light device of claim 1, wherein the heat sink is an aluminous heat sink.

8. The light device of claim 1, wherein the light transmission tube is a plastic tube.

9. The light device of claim 1, wherein a central of the second plate body has a plane and the light bar is disposed on the plane.

10. The light device of claim 1, wherein the light bar is a light-emitting diode (LED) light bar.
